(19) United States
(12) Patent Application Publication
(10) Pub. No.: US 2021/0285512 A1
(43) Pub. Date: Sep. 16, 2021

(54) MATERIALS HAVING GRADED INTERNAL GEOMETRY, AND ASSOCIATED SYSTEMS AND METHODS

(71) Applicant: HyperDamping, Inc., Cambridge, MA (US)

(72) Inventors: Ryan Lee HARNE, Dublin, OH (US); Jason Milton WHALEY, Belmont, MA (US); Katherine SPIES, Boston, MA (US)

(73) Assignee: HyperDamping, Inc., Cambridge, MA (US)

(21) Appl. No.: 17/332,142

(22) Filed: May 27, 2021

Related U.S. Application Data
(63) Continuation of application No. PCT/US2019/063070, filed on Nov. 25, 2019.
(60) Provisional application No. 62/772,503, filed on Nov. 28, 2018.

(51) Int. Cl. F16F 1/377

(52) U.S. Cl. CPC F16F 1/377; F16F 2228/066; F16F 2230/36; F16F 2228/14; F16F 2228/063

(57) ABSTRACT

Systems, apparatus, and methods provide a material, comprising a first section including a first plurality of geometric elements associated with a first characteristic, the first section having a first set of mechanical properties; a second section including a second plurality of geometric elements associated with a second characteristic, the second section having a second set of mechanical properties different from the first set of mechanical properties; and a third section including a third plurality of geometric elements having a change in configuration that provides a transition from the first characteristic to the second characteristic.

### CROSS-REFERENCE TO RELATED APPLICATIONS

This application is a continuation of International Patent Application No. PCT/US2019/063070, filed Nov. 25, 2019, titled “Materials Having Graded Internal Geometry, and Associated Systems and Methods,” which also claims priority to and the benefit of U.S. Provisional Patent Application No. 62/772,503, filed Nov. 28, 2018, titled “Materials Having Graded Internal Geometry, and Associated Systems and Methods,” the disclosure of each of which is incorporated by reference herein.

### TECHNICAL FIELD

The present disclosure relates generally to materials having internal geometric elements, and more specifically, to materials that transition from geometric elements with a first set of characteristics to geometric elements with a second set of characteristics.

### BACKGROUND

Materials used in different applications can be subjected to different loads, stresses, environmental conditions, constraints, and other factors. Therefore, it is desirable to select a material with specific mechanical properties for use in different applications. Materials can be manufactured with different internal geometries and/or attributes to provide for different mechanical properties. For example, a material with a greater tensile strength can be selected to withstand greater tensile loads. Materials can also be manufactured to have mechanical properties that can be actively controlled (e.g., via external stimuli such as temperature, stress, moisture, etc.).

Existing materials, however, may not perform well in applications or environments requiring a transition or change in mechanical properties. For example, many existing materials have unchanging mechanical properties until they fail, e.g., as they are subjected to different loads. Such materials, however, are poorly suited for applications that require a transition or change from one regime in dynamic performance to another. Moreover, such materials may not be adaptable for environments where different loads may be applied to different sections of the materials.

### SUMMARY

Systems, apparatus, and methods described herein relate to materials having a gradient or change in internal geometric structure. Specifically, embodiments described herein relate to materials having geometric elements (e.g., features such as cellular voids or porous architectures) that transition between a first set of characteristics to a second set of characteristics, thereby affecting a change in the macroscopic mechanical properties of the materials. According to some embodiments, a material includes a first section including a first plurality of voids associated with a first characteristic and a second section including a second plurality of voids associated with a second characteristic. The first section can have a first set of mechanical properties, including, for example, macroscopic bulk modulus or stiffness according to a first displacement-force profile. The second section can have a second set of mechanical properties, including, for example, macroscopic bulk modulus or stiffness according to a second displacement-force profile different from the first displacement-force profile. The material further includes a third section that includes a third plurality of voids having a change in configuration that provides a transition from the first characteristic to the second characteristic. In some embodiments, the third section can include portions of the first and/or second sections.

### BRIEF DESCRIPTION OF THE DRAWINGS

FIG. 1 is a schematic diagram of an example material with a transition from a first characteristic to a second characteristic, according to embodiments described herein.

FIG. 2A is a schematic diagram of an example material with transitions in characteristics along multiple dimensions, according to embodiments described herein. FIGS. 2B and 2C depict cross-sectional views of the example material of FIG. 2A, along lines A-A′ and B-B′, respectively, as shown in FIG. 2A.

FIG. 3 is a schematic diagram of an example material with repeating transitions in characteristics, according to embodiments described herein.

FIG. 4 is a side view or a cross-sectional view of an example material with changing internal geometry, according to embodiments described herein.

FIG. 5A is a side view or a cross-sectional view of the example material depicted in FIG. 4, including forces being applied to the material, according to embodiments described herein.

FIG. 5B is a graph of a displacement-force profile associated with the force applied to the material depicted in FIG. 5A, according to embodiments described herein.

FIG. 6 is a side view or a cross-sectional view of an example material with changing internal geometry, according to embodiments described herein.

FIG. 7A is a side view or a cross-sectional view of the example material depicted in FIG. 6, including forces being applied to the material, according to embodiments described herein.

FIG. 7B is a graph of a displacement-force profile associated with the force applied to the material depicted in FIG. 7A, according to embodiments described herein.

FIG. 8 is a side view or a cross-sectional view of an example material with changing internal geometry, according to embodiments described herein.

FIG. 9A is a side view or a cross-sectional view of the example material depicted in FIG. 8, including forces being applied to the material, according to embodiments described herein.

FIG. 9B is a graph of a displacement-force profile associated with the force applied to the material depicted in FIG. 9A, according to embodiments described herein.

### DETAILED DESCRIPTION

Embodiments described herein relate to materials that transition from regions having a first geometric structure to regions having a second geometric structure. The first geometric structure may be associated with a first set of characteristics, and the second geometric structure may be associated with a second set of characteristics different from the first set of characteristics. In some embodiments, a material has a first set of geometric elements associated with a first characteristic that transitions to a second set of geometric elements associated with a second characteristic. The geometric elements can be, for example, geometric features such as cellular voids and/or porous architectures or structures.

In some embodiments, a material can have first and second sections that have different mechanical properties. Examples of mechanical properties include strength, macroscopic bulk modulus or stiffness, ductility, hardness, impact resistance, Poisson's ratio, deformation, etc., and can be anisotropic properties (e.g., properties that vary with orientation). For example, a material can have a first and second sections with different displacement-force profiles. The first and second sections can have different internal geometric structure (e.g., have differently configured geometric elements, such as voids). The material can have a gradient in one or more directions, producing a transition from the internal geometric structure of the first section to the internal geometric structure of the second section. In some embodiments, at least one of the first or second sections can provide a smooth (e.g., progressive) transition from one regime of dynamic mechanical performance to another. For example, a section of the material can provide a progressive transition from a first mechanical property (e.g., a first displacement-force relationship, Poisson's ratio, anisotropic property) to a second mechanical property (e.g., a second displacement-force relationship, Poisson's ratio, anisotropic property), thereby avoiding sudden collapse behavior.

Materials described herein can be useful in many industrial applications. For example, materials providing progressive collapse behavior and/or changing mechanical properties (e.g., via a graded internal geometry) can be useful in applications including, for example, architectural design, electronics packaging and padding, vibration and shock isolation including the manufacture of vibration isolators and mounts for various industry sectors (e.g., manufacturing, automotive, aerospace, construction, civil infrastructure, etc.) where such isolators/mounts are used as interfaces between other components to diminish the transmission of shock and vibration, noise isolation, seat systems for comfort, ride quality, and/or occupant safety, and consumer product development for sound and vibration quality and long-life performance.

Materials having an internal geometric gradient, e.g., in one or more directions, can be engineered, programmed, tuned, or otherwise configured to have mechanical properties suited for different external loads, stresses, etc. In some embodiments, such materials can be constructed with sections having different mechanical properties. For example, a material can have a first section with a discrete change in collapse behavior and a second section with a smooth or progressive change in collapse behavior. Such a material can be useful in applications requiring support for different external forces in different regions. The direction(s), amount of change per distance, and/or other characteristics of the gradient of the material can be adjusted to suit different applications.

While there are existing materials with different mechanical properties, these materials perform poorly in applications that require a transition or change in mechanical properties. Materials known as “smart materials” that have properties that can change in response to different external stimuli (e.g., stress, temperature, moisture, pH, electric or magnetic fields, light, or chemical compounds) are expensive to produce and have certain drawbacks when compared to materials with static material properties. For example, smart materials can be difficult to transport, susceptible to change and/or degradation when exposed to different environmental conditions, and be energy intensive to produce. Systems, apparatus, and methods are described herein for materials that can be configured to have dynamic mechanical behavior without having the drawbacks of existing material structures.

Materials described herein can be manufactured using a variety of techniques, including, for example, molding (e.g., injection, foam, gas-assist), polymerization, casting, three-dimensional printing, etc.

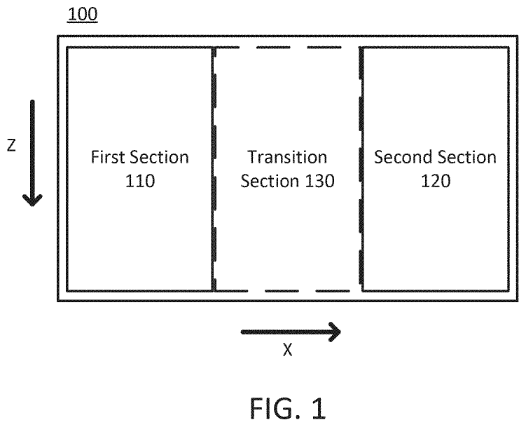

FIG. 1 is a schematic illustration of an example embodiment of a gradient material 100. The gradient material 100 can include a first section 110 that has an internal geometric structure (e.g., microstructure) including geometric element(s) associated with a first set of characteristics, and a second section 120 that has an internal geometric structure (e.g., microstructure) including geometric element(s) associated with a second set of characteristics different from the first set of characteristics. Optionally, the gradient material 100 can also include a transition section 130 that provides a transition between the internal geometric structure of the first section 110 and that of the second section 120 (e.g., via geometric elements having characteristics that gradually change from the first set of characteristics to the second set of characteristics). In some embodiments, the transition section 130 can overlap and/or encompass portions of the first section 110 and/or second section 120. The transition from the internal geometric structure of the first section 110 to that of the second section 120 can be gradual (e.g., at a constant and/or varying rate of change) and/or abrupt.

In some embodiments, the geometric elements can be voids or porous structures. The geometric elements can have or be associated with different characteristics or attributes, including different shapes, sizes, densities, etc. For example, the geometric elements can have a cross-sectional shape that is a circle or any polygonal shape (e.g., square, triangle, hexagon), with or without curved sides and/or corners. The shape of the geometric elements can be arbitrary or selected based on the specific application (e.g., to achieve a specific set of mechanical properties, such as a specific displacement-force profile, macroscopic bulk modulus or stiffness, Poisson's ratio, anisotropic property, or other property). The geometric elements can vary in size, e.g., from a nanometer to meter scale, depending on the overall size and/or properties of the gradient material 100. For example, a gradient material having larger dimensions can include voids with larger dimensions. The material can have geometric elements that are in an ordered arrangement or a less ordered and/or disordered arrangement, to achieve a different set of mechanical properties (e.g., different displacement-force profiles, macroscopic bulk moduli or stiffnesses, Poisson's ratios, anisotropic properties).

The gradient material 100 can have geometric elements with shape, size, density, and/or other attributes that change between the first section 110 and the second section 120. For example, the first section 110 can include voids in an ordered arrangement and the second section 120 can include voids in a less ordered and/or disordered arrangement. Alternatively or additionally, going from the first section 110 to the second section 120, the voids can change in shape, e.g., from a square shape to an amorphous shape. Alternatively or additionally, going from the first section 110 to the second section 120, the voids can change in size, e.g., from a meter scale to a nanometer scale, and all ranges in between.

The gradient material 100 can be formed of a material that is elastically or plastically deformable, depending on the desired application. For example, in applications requiring cycling of multiple load and unload sequences, the gradient material 100 can be formed of an elastic material that can deform from an initial, unloaded configuration to a loaded configuration, and back to its unloaded configuration. Alternatively, in single use applications where the performance of the gradient material 100 are required to withstand one-time use, the gradient material 100 can be formed of a plastic material. Examples of suitable materials include foams, elastomers, natural material, polymers, composites, and metals.

The gradient or transition in internal geometric structure of the gradient material 100 can be in a single direction, e.g., along an x-axis direction, as depicted in FIG. 1. Alternatively, the gradient of the gradient material 100 can be in multiple directions, e.g., three directions such as along a length, width, and height of the material. In such embodiments, the change in geometric element attributes along each axis or direction can involve a change in different characteristics of the geometric elements. For example, the geometric elements may change in shape along a first direction, in size along a second direction, and from ordered to less ordered and/or disordered along a third direction. Alternatively, in some embodiments, the change in geometric element attributes can be the same along each axis. Stated more generally, the gradient material 100 can transition from having geometric elements associated with a first set of characteristics to having geometric elements associated with a second set of characteristics that are different from the first set of characteristics, along a first axis. Alternatively or additionally, the gradient material 100 can transition from having geometric elements associated with the first set of characteristics to having geometric elements associated with a third set of characteristics that are different from one or more of the first set of characteristics and the second set of characteristics, along a second axis. And alternatively or additionally, the gradient material 100 can transition from having geometric elements associated with the first set of characteristics to having geometric elements associated with a fourth set of characteristics that are different from one or more of the first set of characteristics, the second set of characteristics, and the third set of characteristics, along a third axis. In some embodiments, the gradient material 100 can have additional gradients along additional directions (e.g., a fourth direction).

The first section 110 can have a first set of mechanical properties, and the second section can have a second set of mechanical properties that are different from the first set of mechanical properties. Examples of mechanical properties include strength, macroscopic bulk modulus or stiffness, ductility, hardness, impact resistance, Poisson's ratio, deformation, etc., and can be anisotropic properties (e.g., properties that vary with orientation). In an embodiment, the first section 110 can deform according to a first displacement-force profile, and the second section 120 can deform according to a second displacement-force profile that is different from the first displacement-force profile. Thus, if separate external forces were applied in a direction along a z-axis (i.e., an axis perpendicular to the x-axis and perpendicular to the direction of the gradient) to the first section 110 and the second section 120, then the first section 110 can deform separately from and differently than the second section 120. Alternatively, if a single force were applied in a direction along the x-axis (i.e., in the direction of the gradient) such that both the first section 110 and the second section 120 are subjected to the force, then the gradient material 100 can deform according to a third displacement-force profile based on the combined deformation or collapse behavior of the first section 110 and the second section 120. For example, the third displacement-force profile can have (i) a first region with a displacement-force relationship associated with a collapse of the geometric element(s) of the first section 110 (e.g., similar to a region of the first displacement-force profile) and (ii) a second region with a displacement-force relationship associated with a collapse of the geometric element(s) of the second section 120 (e.g., similar to a region of the second displacement-force profile). By adjusting the characteristics of the geometric elements of the first section 110, the geometric elements of the second section 120, and/or the gradient (e.g., direction of change relative to a direction of the force being applied, rate of change), the mechanical properties of the gradient material 100 can be adjusted to suit different applications.

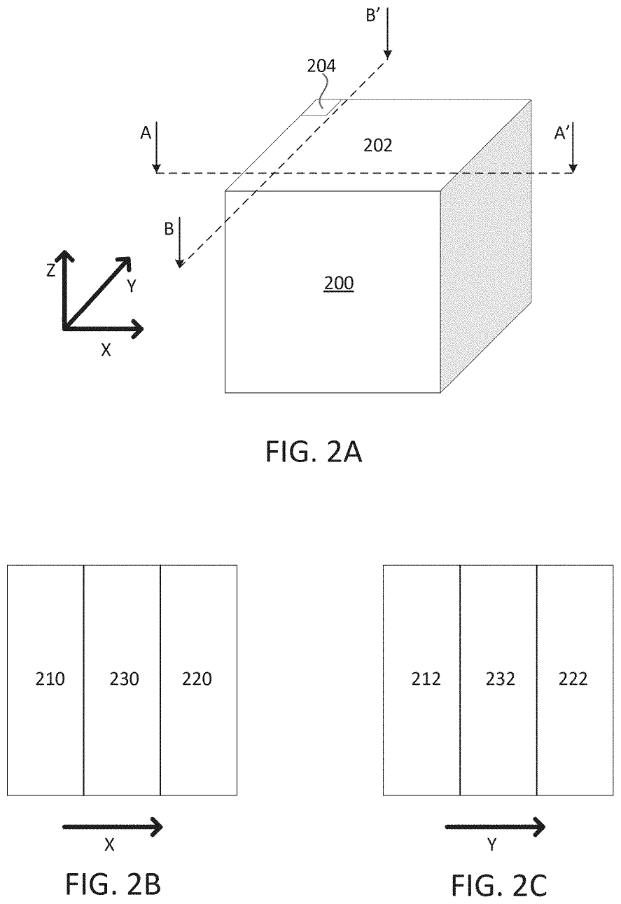

FIG. 2A is a schematic illustration of an example embodiment of a gradient material 200, shown in three dimensional form. The gradient material 200 is schematically depicted as having a cuboid or box-shaped structure; however, it should be understood that the gradient material 200 can have any three-dimensional shape or configuration, including, for example, a pyramidal shape, a cylindrical shape, a conical shape, a spherical shape, etc. The gradient material 200 can have component(s) that are functionally and/or structurally similar to those of gradient material 100 and/or other materials described herein. For example, the gradient material 200 can have different sections having different internal geometries and/or gradual or abrupt transitions between the internal geometries of those sections.

FIGS. 2B and 2C depict cross-sectional views of the gradient material 200. Specifically, FIG. 2B depicts a cross-sectional view of the gradient material 200 along line A-A′, and FIG. 2C depicts a cross-sectional view of the gradient material 200 along line B-B′. As shown in FIG. 2B, the gradient material 200 can have a plurality of sections 210, 220, 230, each having different internal geometric elements. For example, the section 210 can have geometric element(s) with a first set of characteristics, the section 220 can have geometric element(s) with a second set of characteristics, and the section 230 can have geometric element(s) that transition from the first set of characteristics to the second set of characteristics. In some embodiments, the section 230 can overlap and/or encompass a portion of sections 210, 220. In some embodiments, one or both of sections 210, 220 may provide a transition between their respective geometric elements and, therefore, the section 230 can correspond to one or more of section 210, 220. The transition from the geometric elements with the first set of characteristics to the geometric elements with the second set of characteristics can be gradual (e.g., at a constant and/or varying rate of change) and/or abrupt, depending on the application.

Similarly, as depicted in FIG. 2C, the gradient material 200 can have a plurality of sections 212, 222, 232, each having different internal geometric elements. For example, the section 212 can have geometric element(s) with a third set of characteristics, the section 222 can have geometric element(s) with a fourth set of characteristics, and the section 232 can have geometric element(s) that transition from the third set of characteristics to the fourth set of characteristics. In some embodiments, the section 212 can have geometric element(s) with the same characteristics as those of the section 210, i.e., the third set of characteristics can be the same as the first set of characteristics. Alternatively or additionally, the section 222 can have geometric element(s) with the same characteristics as those of the section 220, i.e., the fourth set of characteristics can be the same as the second set of characteristics. In other embodiments, the section 212 can have geometric element(s) with characteristics that are different from those of the section 210, and/or section the 222 can have geometric elements) with characteristics that are different from those of the section 220. For example, the section 210 has geometric elements having a square cross-sectional shape that transitions into the section 220 that has geometric elements having amorphous cross-sectional shape, while the section 212 has geometric elements having an ordered arrangement that transitions to the section 222 that has geometric elements having a less ordered and/or disordered arrangement. The section 232 can be similar in structure and/or function to the section 230. For example, the section 232 can include and/or correspond to one or more of the sections 212, 222.

As depicted in FIGS. 2A-2C, the gradient material 200 can have a gradient in at least two directions, e.g., in directions along the x-axis and the y-axis. While not depicted, the gradient material 200 can have gradients in additional directions, e.g., in a direction along the z-axis. As noted above, the characteristics of the geometric elements that change in each direction can be different or the same. For example, the gradient material 200 can transition from having geometric elements in an ordered arrangement to geometric elements having a less ordered and/or disordered arrangement along a first axis (e.g., the x-axis), and transition from having geometric elements with a square cross-sectional shape to geometric elements with an amorphous cross-sectional shape along a second axis (e.g., the y-axis). Alternatively, the gradient material 200 can transition from having ordered to less ordered and/or disordered geometric elements along two or more directions (e.g., along both the x-axis and the y-axis).

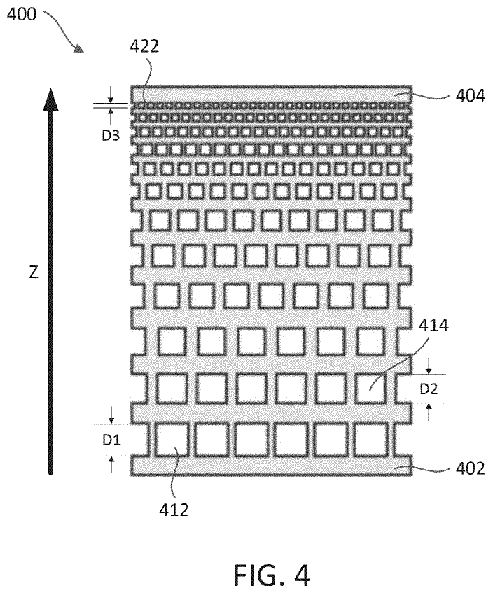

Depending on the characteristics of the geometric elements of any particular section or area of the gradient material 200, that section or area may have different mechanical properties (e.g., a different displacement-force profile, different collapse behavior, different Poisson's ratio, different anisotropic property). For example, when a local uniaxial force is applied in a direction perpendicular to a surface 202 of the gradient material 200 above an area 204, the area 204 would exhibit mechanical behavior based on the characteristics of the geometric elements below that area 204 of the surface 202. As further described below with reference to FIGS. 4-9B, external forces applied to areas of a gradient material 200 with different internal geometry can exhibit a sudden collapse trend in mechanical properties (e.g., so as to realize low, near zero stiffness or negative stiffness) or a progressive shift in mechanical properties (e.g., from a linear elastic state, to a softening stiffness state associated with the sequential collapse of internal geometric elements, and then to a hard state after a sufficient number of internal geometric elements have collapsed). The external forces applied to the gradient materials described herein can include, for example, displacements, loads, stresses, strains, or boundary conditions that give rise to deformation of the material and its associated internal geometric elements.

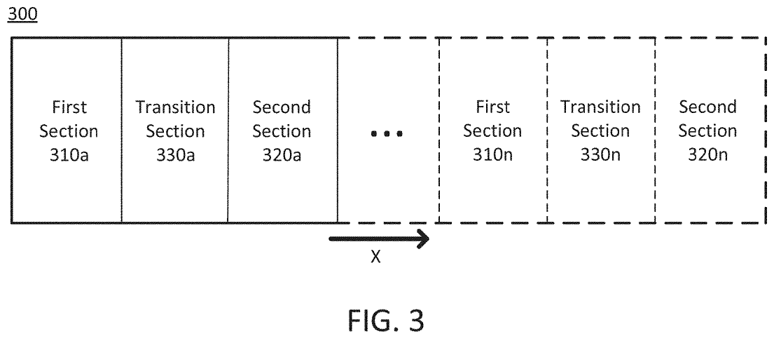

FIG. 3 is a schematic illustration of an example gradient material 300, according to embodiments disclosed herein. The gradient material 300 can have component(s) that are functionally and/or structurally similar to those of gradient materials 100, 200 and/or other materials described herein. For example, the gradient material 300 can include a first section 310a with geometric element(s) associated with a first set of characteristics, a second section 320a with geometric element(s) associated with a second set of characteristics, and a transition section 330a that provides a transition from the first section 310a to the second section 320a. In some embodiments, the transition section 330a can include portions of the first section 310a and/or the second section 320a, or correspond to one or both of the first section 310a and/or the second section 320a.

The gradient or transition in internal geometric structure from the first section 310a to the second section 320a can be along the x-axis, as depicted in FIG. 3. While not depicted, the gradient material 300 can also have other gradients in other directions (e.g., along a y-axis or z-axis of the material 300). Optionally, the gradient material 300 can have additional gradients along the x-axis that transition between having geometric elements with different characteristics. For example, the gradient material 300 can have additional sections 310b, 320b, 330b, . . . 310b, 320n, 330n that transition between two different internal geometric structures (e.g., between a section 310b, . . . 310n with geometric element(s) having one set of characteristics and a section 320b . . . 320n with geometric element(s) having a different set of characteristics, respectively). Each set of sections 310n, 320n, 330n can transition between sections having internal geometric structures similar to or the same as the sections 310a, 320a, 330a, respectively, or transition between sections having internal geometric structures different from sections 310a, 320a, 330a. While not depicted, similar gradients to those depicted along the x-axis in FIG. 3 can exist in other directions (e.g., along the y-axis or z-axis of the material 300). Thus, when extrapolated in a three-dimensional space, gradient materials described herein can repeatedly change in internal geometric structure (e.g., have geometric elements with different characteristics) along any number of directions, with such gradients forming additional sections with different internal geometric structure. In some embodiments, gradients along different directions can overlap and/or intersect to form new sections with geometric elements that include a combination of characteristics associated with the different gradients.

FIG. 4 illustrates a side view of an example gradient material 400, according to embodiments described herein. The side view of FIG. 4 can be representative of a cross-sectional view of the example gradient material 400. The gradient material 400 can have component(s) that are structurally and/or functionally similar to other gradient materials described herein (e.g., gradient materials 100, 200, 300). For example, the gradient material 400 has geometric elements in the form of voids. The gradient material 400 can be formed from an elastically or plastically deformable material, e.g., depending on the desired application.

The gradient material 400 has a gradient that changes along a z-axis (e.g., a vertical direction or height of the material). The gradient extends from a first side 402 of the gradient material 400 to a second side 404 of the gradient material 400. The gradient can be associated with a change in size of the voids. Specifically, the gradient can provide a transition from a first set of voids 412 having a lateral dimension D1 to a second set of voids 422 having a lateral dimension D3, where the lateral dimension D1 of the first set of voids 412 is greater than the lateral dimension D3 of the second set of voids 422. In some embodiments, the lateral dimension D1 of the first set of voids 412 can be one or several magnitudes of order greater than the lateral dimension D3 of the second set of voids 422. For example, the lateral dimension D1 of the first set of voids 412 can be on a micrometer scale (e.g., 1 micrometer), while the lateral dimension of the second set of voids 422 can be on a nanometer scale (e.g., 1 nanometer). In other embodiments, the lateral dimension D2 of the second set of voids 422 can be about 1% to about 10% of the lateral dimension D1 of the first set of voids 412. Alternatively, other ranges of relative sizes between the first set of voids 412 and the second set of voids 422 can be used, e.g., about 0.01% to about 25% and all ranges in between.

The gradient material 400 can transition from the first set of voids 412 to the second set of voids 422 via intermediate sets of voids, e.g., a set of voids 414 with a lateral dimension D2. The lateral dimensions of the intermediate sets of voids 414 can fall between the lateral dimension D1 of the first set of voids 412 and the lateral dimension D3 of the second set of voids 422. For example, the lateral dimension D2 of the intermediate set of voids 414 can be smaller than the lateral dimension D1 of the first set of voids 412 but larger than the lateral dimension D3 of the second set of voids 422. With each successive intermediate set of voids, the lateral dimension of the voids can decrease in size so as to provide a transition between the first set of voids 412 and the second set of voids 422. In some embodiments, each intermediate set of voids can be a fixed amount or percentage smaller or larger than its adjacent set of voids. In some embodiments, each intermediate set of voids can change in size a different amount or percentage from its adjacent set of voids, e.g., so as to create regions with greater or less change in void size.

While the gradient material 400 is depicted as having voids with square cross-sectional shape and a rectangular cross-sectional profile, it can be appreciated that gradient material 400 can have other void shapes and/or cross-sectional profiles. The characteristics of the gradient material 400, its voids, and/or its gradient can be specifically tuned or designed to obtain desired variable mechanical properties over the spatial extent of the gradient material 400 that is used.

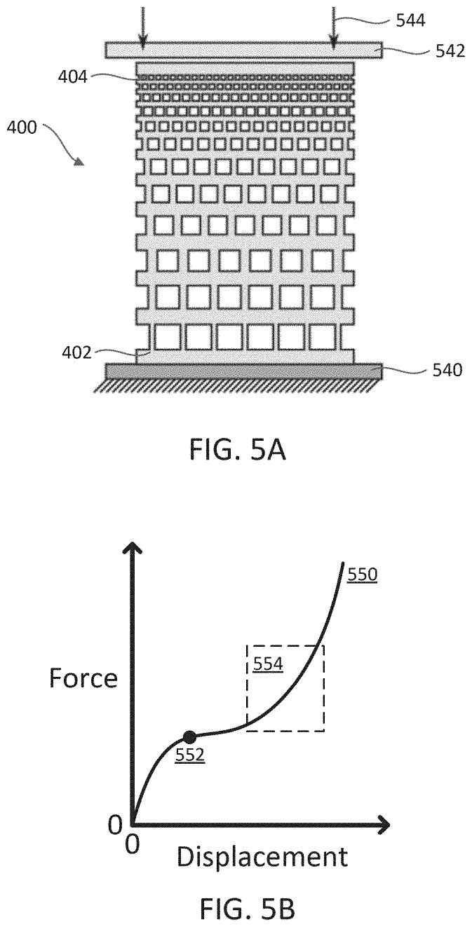

FIG. 5A illustrates an external load 544 being applied to the side 404 of the gradient material 400. For illustration and explanation purposes, the gradient material 400 is depicted as being positioned on a flat surface 540 that is represented as not moving or compressing in response to the application of the external load 544 to the gradient material 400, and the external load 544 is depicted as being evenly applied (e.g., via a plate 542 or other flat structure) across the side 404 of the gradient material 400 (e.g., a top surface of the gradient material 400). While the plate 542 and the surface 540 are depicted as flat, smooth structures, it can be appreciated that gradient material 400 can be used in applications with other surface profiles (e.g., a curved, textured, and/or angled surface). Examples of displacement applications such as that depicted in FIG. 5A can be for supporting a structure (e.g., a machine component) to prevent passage of vibration from the structure to another structure (e.g., a fixed ground or other machine component).

With increasing application of the external load 544 (i.e., increasing force), the gradient material 400 can displace according to a displacement-force profile 550, such as depicted in FIG. 5B. The displacement-force profile 550 can have an initial linear relationship (e.g., associated with a linear elastic state), followed by a point 552 at which the gradient material 400 begins to soften and the larger sized voids (e.g., voids 412) near the first side 402 of the gradient material 400 collapse, and then followed by a region 554 associated with the progressive collapse of the smaller sized voids (e.g., voids 422) near the second side 404 of the gradient material 400. And after a sufficient amount of the smaller and larger sized voids have collapsed (i.e., the boundaries defining the voids have self-contacted), the material can exhibit a hardened state.

As depicted in FIG. 5B, a section of the gradient material 400 including the larger sized voids (e.g., voids 412) exhibits a sudden collapse trend, while a section of the gradient material 400 including the smaller sized voids (e.g., voids 422) exhibits a more progressive collapse trend. Together, the different sections of the gradient material 400 provide a material with variable mechanical properties, e.g., displacement-force behavior that changes with increasing application of force, which can be useful in applications requiring variable mechanical properties.

While FIG. 5B depicts that the stiffness (i.e., slope of the displacement-force profile) of the gradient material 400 can change with increasing application of force, it can be appreciated that gradient material 400 can exhibit or have other mechanical properties that change based on the specific microstructure of the gradient material 400. For example, the gradient material 400 can have discrete or progressive changes in mechanical properties including, for example, Poisson's ratio, an anisotropic property, etc.

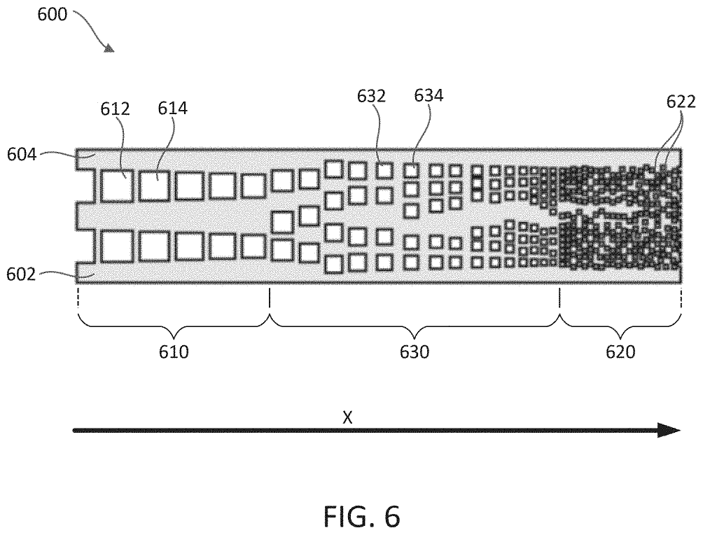

FIG. 6 illustrates a side view of an example gradient material 600, according to embodiments described herein. The side view of FIG. 6 can be representative of a cross-sectional view of the example gradient material 600. The gradient material 600 can have component(s) that are structurally and/or functionally similar to other gradient materials described herein (e.g., gradient materials 100, 200, 300, 400). For example, the gradient material 600 has geometric elements in the form of voids. The gradient material 600 can be formed from an elastically or plastically deformable material, e.g., depending on the desired application.

The gradient material 600 has a gradient that changes along an x-axis (e.g., in a direction along first and second sides 602, 604 of the material). The gradient material 600 has a first section 610 including a first set of voids (e.g., voids 612, 614), a second section 620 including a second set of voids (e.g., voids 622), and a transition section 630 including a third set of voids (e.g., voids 632, 634). The first set of voids 612, 614 can be associated with or have a first set of characteristics, and the second set of voids 622 can be associated with or have a second set of characteristics. The third set of voids 632, 634 of the transition section 630, as well as portions of the first and second set of voids in the sections 610, 620, can have a change in configuration that provides a transition from having the first set of characteristics to having the second set of characteristics. The first set of voids 612, 614 can be associated with characteristics including, for example, larger lateral dimensions (e.g., lateral dimensions greater than a first predefined value) and being in an ordered arrangement (e.g., each void being disposed at preset distances from other voids around it). The second set of voids 622 can be associated with characteristics including, for example, smaller lateral dimensions (e.g., lateral dimensions smaller than a second predefined value) and being in a less ordered or disordered arrangement.

Within each section 610, 620, 630, different subsets of voids can be associated with further differences in characteristics. For example, in section 610, a first subset of voids 612 can have a greater lateral dimension than a second subject of voids 614. And in section 630, a first subset of voids 632 can have a greater lateral dimension and/or more ordered arrangement than a second subset of voids 634. The different characteristics between the different subsets of voids can be associated with the gradient or transition from having the first set of characteristics to having the second set of characteristics. Stated differently, the gradient or transition from having the first set of characteristics to having the second set of characteristics can be formed of portions of one or more of the first set of voids, the second set of voids, and/or the third set of voids.

While the gradient material 600 is depicted as having voids with square cross-sectional shape and a rectangular cross-sectional profile, it can be appreciated that gradient material 600 can have other void shapes and/or cross-sectional profiles. The characteristics of the gradient material 600, its voids, and/or its gradient can be specifically tuned or designed to obtain desired variable mechanical properties over the spatial extent of the gradient material 600 that is used.

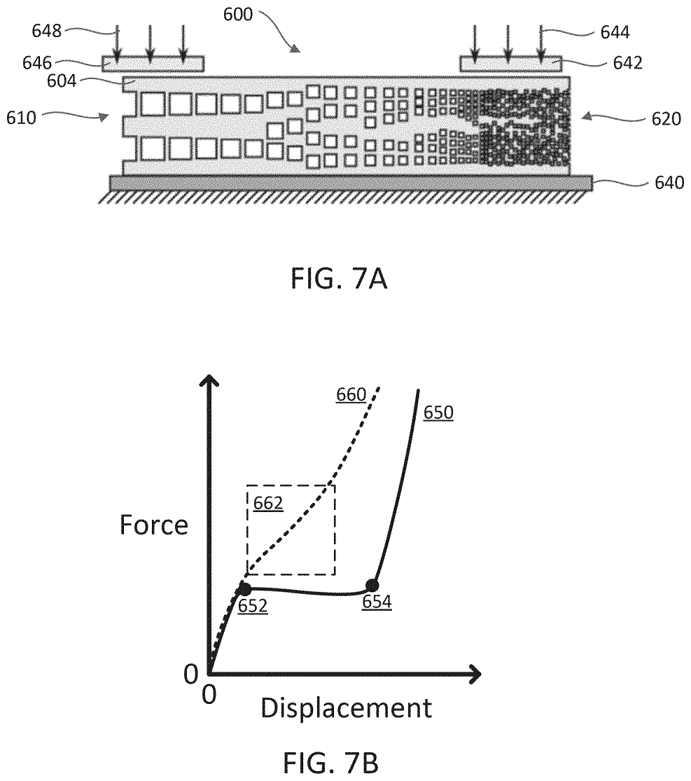

FIG. 7A illustrates external loads 644, 648 being applied to the side 604 of the gradient material 600. For illustration and explanation purposes, the gradient material 600 is depicted as being positioned on a flat surface 640 that is represented as not moving or compressing in response to the application of the external loads 644, 648, and the external loads 644, 648 are depicted as being unidirectional loads that are applied over specific areas of the gradient material (e.g., via plates 642, 646, respectively, or another flat structure). As depicted, the external load 644 is applied over a first area overlaying the section 620 of the gradient material 600, and the external load 648 is applied over a second area overlaying the section 610 of the gradient material 600. In this illustration, it is assumed that the external load 644 applied over the section 620 of the gradient material 600 does not have an effect on the section 610 of the gradient material 600, and vice versa. Examples of displacement applications such as that depicted in FIG. 7A can be for supporting a structure (e.g., a machine component) to prevent passage of vibration from the structure to another structure (e.g., a fixed ground or other machine component). In particular, the supported structure can have multiple points that contact different areas (e.g., in sections 610, 620) of the gradient material 600.

FIG. 7B illustrates the displacement-force profiles of the sections 610, 620 of the gradient material 600, with increasing application of the external loads 644, 648. The first section 610 can have a displacement-force profile 650 that has an initial linear relationship (e.g., associated with a linear elastic state), up until a point 652 at which the first set of voids (e.g., voids 612, 614) undergoes a sudden collapse, resulting in a near-zero and/or negative displacement-force relationship in which the section 610 of the material displaces to a point 654. At point 654 and beyond, contact between the boundaries defining the first set of voids then causes the gradient material 600 to exhibit a displacement-force relationship associated with a hardened state, as additional force is applied to the material. The second section 620 can have a displacement-force profile 660 that has an initial linear relationship similar to that of the first section 610, followed by a region 662 associated with a progressive collapse of the second set of voids (e.g., voids 622).

As depicted, the second section 620 exhibits a progressive collapse behavior, which can be attributed to the specific characteristics of the second set of voids, e.g., smaller void size and less ordered and/or disordered arrangement. In comparison, the first section 610 with a larger and more ordered set of voids exhibits a sudden collapse behavior as the void collapse together once a set amount of load is applied (e.g., the amount of load associated with point 652). Accordingly, the characteristics of the voids and/or gradient of the gradient material 600 can be altered to obtain material with variable mechanical properties along its length.

While FIG. 7B depicts that different sections (e.g. sections 610, 620) of gradient material 600 can have different stiffness (i.e., as represented by the slope of their respective displacement-force profiles), it can be appreciated that gradient material 600 and/or sections of gradient material 600 can have other mechanical properties that change based on the specific microstructure of the gradient material 600. For example, different sections 610, 620 of the gradient material 600 can have discrete or progressive changes in mechanical properties including, for example, Poisson's ratio, an anisotropic property, etc.

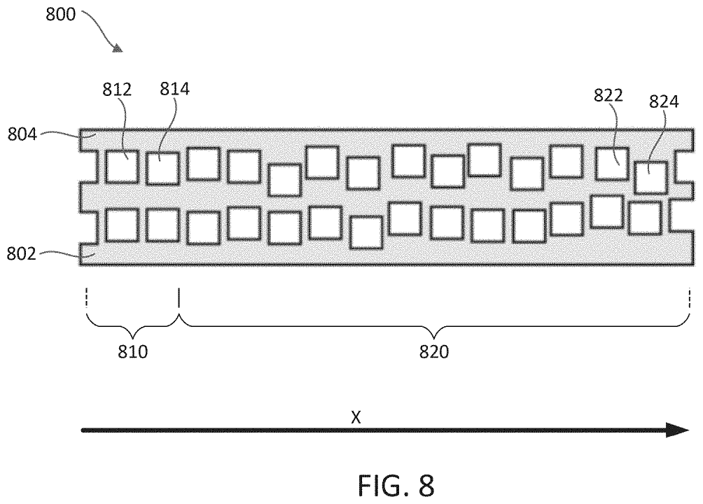

FIG. 8 illustrates a side view of an example gradient material 800, according to embodiments described herein. The side view of FIG. 8 can be representative of a cross-sectional view of the example gradient material 800. The gradient material 800 can have component(s) that are structurally and/or functionally similar to other gradient materials described herein (e.g., gradient materials 100, 200, 300, 400, 600). For example, the gradient material 800 has geometric elements in the form of voids. The gradient material 800 can be formed from an elastically or plastically deformable material, e.g., depending on the desired application.

Similar to the gradient material 600, the gradient material 800 can have a gradient that changes along an x-axis (e.g., in a direction along first and second sides 802, 804 of the material). The gradient material 800 has a first section 810 including a first set of voids (e.g., voids 812, 814), and a second section 820 including a second set of voids (e.g., voids 822, 824). The first set of voids 812, 814 can be associated with or have a first set of characteristics, and the second set of voids 822, 824 can be associated with or have a second set of characteristics. In particular, the first set of voids 812, 814 can be associated with having an ordered arrangement (e.g., each void being disposed at preset distances from other voids around it), and the second set of voids 822, 824 can be associated with having a less ordered or disordered arrangement. The voids, including the first set of voids 812, 814 and the second set of voids 822, 824, can transition from being associated with the first set of characteristics (i.e., from having an ordered arrangement) to being associated with the second set of characteristics (i.e., from having a disordered arrangement). The transition can occur abruptly and/or occur over portion of the length of the gradient material. Different from the gradient material 600, the voids of the gradient material 800 can remain consistent throughout the material, e.g., voids 812, 814, 822, 824 can have the same lateral dimensions.

While the gradient material 800 is depicted as having voids with square cross-sectional shape and a rectangular cross-sectional profile, it can be appreciated that gradient material 800 can have other void shapes and/or cross-sectional profiles. The characteristics of the gradient material 800, its voids, and/or its gradient can be specifically tuned or designed to obtain desired variable mechanical properties over the spatial extent of the gradient material 800 that is used.

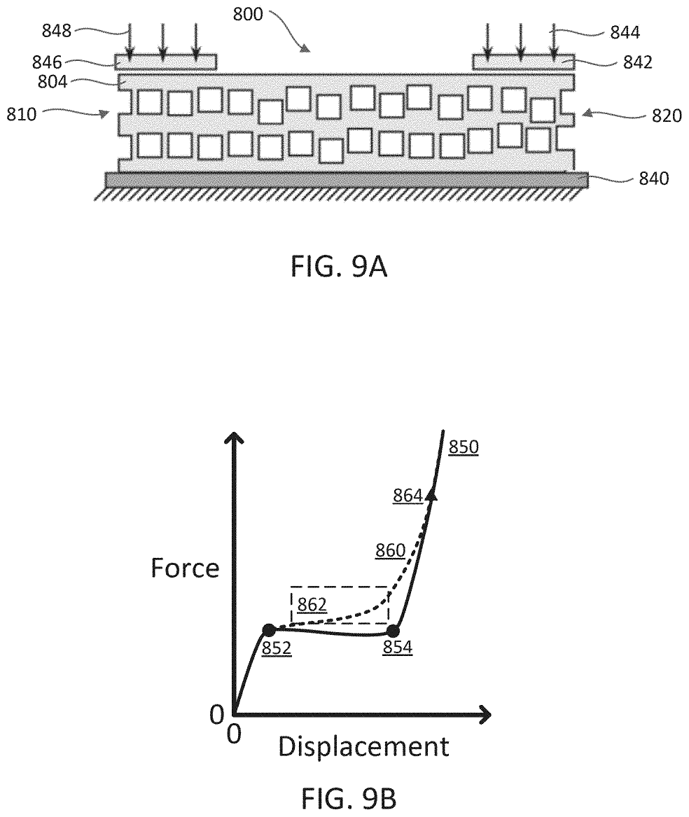

FIG. 9A illustrates external loads 844, 848 being applied to the side 804 of the gradient material 800. For illustration and explanation purposes, the gradient material 800 is depicted as being positioned on a flat surface 840 that is represented as not moving or compressing in response to the application of the external loads 844, 848, and the external loads 844, 848 are depicted as being unidirectional loads that are applied over specific areas of the gradient material (e.g., via plates 842, 846, respectively, or another flat structure). As depicted, the external load 844 is applied over a first area overlaying the section 820 of the gradient material 800, and the external load 848 is applied over a second area overlaying the section 810 of the gradient material 800. In this illustration, it is assumed that the external load 844 applied over the section 820 of the gradient material 800 does not have an effect on the section 810 of the gradient material 800, and vice versa. Examples of displacement applications such as that depicted in FIG. 9A can be for supporting a structure (e.g., a machine component) to prevent passage of vibration from the structure to another structure (e.g., a fixed ground or other machine component). In particular, the supported structure can have multiple points that contact different areas (e.g., in sections 810, 820) of the gradient material 800.

FIG. 9B illustrates the displacement-force profiles of the sections 810, 820 of the gradient material 800, with increasing application of the external loads 844, 848. The first section 810 can have a displacement-force profile 850 similar to the displacement-force profile 650 of the first section 610 of the gradient material 600 (as illustrated in FIG. 7B). For example, the first section 810 can have an initial linear relationship, up until a point 852 at which the first set of voids (e.g., voids 812, 814) undergoes a sudden collapse, resulting in a near-zero and/or negative displacement-force relationship until the material displaces to a point 854. The second section 820 can have a displacement-force profile 860 that has an initial linear relationship similar to that of the first section 810, followed by a region 862 associated with a more progressive collapse of the second set of voids (e.g., voids 822, 824). At point 864, once the second set of voids have collapsed, the displacement-force relationship of the second section 820 can be similar once again to the displacement-force relationship of the first section 810.

As depicted, the second section 820, which includes voids having a less ordered arrangement, can exhibit collapse behavior that is less sudden (i.e., has a greater slope) when compared to the first section 810, which includes voids have an ordered arrangement. Accordingly, the characteristics of the voids and/or gradient of the gradient material 800 can be altered to obtain material with variable mechanical properties along its length.

While FIG. 9B depicts that different sections (e.g. sections 810, 820) of gradient material 800 can have different stiffness (i.e., as represented by the slope of their respective displacement-force profiles), it can be appreciated that gradient material 800 and/or sections of gradient material 800 can have other mechanical properties that change based on the specific microstructure of the gradient material 800. For example, different sections 810, 820 of the gradient material 800 can have discrete or progressive changes in mechanical properties including, for example, Poisson's ratio, an anisotropic property, etc.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

1. An article, comprising:
a material including:
a first section including a first microstructure, the first microstructure having a first characteristic;
a second section including a second microstructure, the second microstructure having a second characteristic different from the first characteristic; and
a transition section providing a transition from the first microstructure to the second microstructure,
the first microstructure configured to react differently than the second microstructure in response to a force applied to the material such that the material has a mechanical property that changes along a length of the material extending through the first section and second section.

2. The article of claim 1, wherein the transition section includes geometric elements having characteristics that gradually transition from the first characteristic to the second characteristic.

3. The article of claim 1, wherein the transition section overlaps with at least one of the first section or the second section.

4. The article of claim 1, wherein the transition section is disposed between and adjacent to the first section and the second section.

5. The article of claim 1, wherein the material is an elastic material such that the material is configured to deform from an unloaded configuration to a loaded configuration in response to the force being applied to a surface of the material and to revert back to the unloaded configuration after the force is not being applied.

6. The article of claim 1, wherein the material is a polymer material such that the material is configured to deform from an unloaded configuration to a loaded configuration in response to the force being applied to a surface of the material and to remain in the loaded configuration after the force is not being applied.

7. The article of claim 1, wherein the first characteristic is a first lateral dimension and the second characteristic is a second lateral dimension that is less than the first lateral dimension,
the transition from the first microstructure to the second microstructure including geometric elements that transition in lateral dimension from about the first lateral dimension to about the second lateral dimension.

8. The article of claim 1, wherein the first characteristic is a first geometric shape and the second characteristic is a second geometric shape,
the transition from the first microstructure to the second microstructure including geometric elements that transition in shape from about the first shape to about the second shape.

9. The article of claim 1, wherein the first characteristic is an ordered arrangement and the second characteristic is a disordered arrangement,
the transition from the first microstructure to the second microstructure including geometric elements that transition from being in the ordered arrangement to being in the disordered arrangement.

10. The article of claim 1, wherein the transition from the first microstructure to the second microstructure occurs along at least two directions.

11. The article of claim 1, wherein the first section is configured to displace according to a first displacement-force profile, and the second section is configured to displace according to a second displacement-force profile,
the first displacement-force profile including a change in slope greater than that of the second displacement-force profile.

12. The article of claim 1, wherein:
the first section is configured to displace according to a first displacement-force profile that has (1) a positive slope upon application of increasing force to a collapse point representing a sudden collapse of the first microstructure and (2) a near-zero slope upon further application of increasing force beyond the collapse point, and
the second section is configured to displace according to a second displacement-force profile that has a positive slope that changes throughout a region representing a progressive collapse of the second microstructure.

13. The article of claim 1, wherein:
the first section is configured to displace according to a displacement-force profile that has a collapse point representing a sudden collapse of the first microstructure, and
the second section is configured to displace according to a second displacement-force profile that has a region that changes in slope representing a progressive collapse of the second microstructure.

14. The article of claim 1, wherein the first microstructure and the second microstructure include voids.

15. The article of claim 1, wherein the material is a first material, and at least one of the first microstructure and the second microstructure includes a second material.

16. The article of claim 1, wherein the mechanical property is at least one of: a strength, a stiffness, a ductility, a resonant frequency, a Poisson's ratio, a modulus of elasticity, or a thermal property.

17. An article, comprising:
a material including:
a first section including a first set of geometric elements, the first set of geometric elements having a first set of characteristics;
a second section including a second set of geometric elements, the second set of geometric elements having a second set of characteristics; and
a transition section including a third set of geometric elements, the third set of geometric elements having a third set of characteristics that change to provide a transition from the first set of characteristics to the second set of characteristics,
the first set of geometric elements configured to react differently than the second set of geometric elements in response to a force applied to the material such that the material has a mechanical property that changes along a length of the material extending through the first section and the second section.

18. The article of claim 17, wherein the transition section overlaps with at least one of the first section or the second section, and the third set of geometric elements correspondingly includes at least one of a portion of the first set of geometric elements or a portion of the second set of geometric elements.

19. The article of claim 17, wherein the transition section is disposed between and adjacent to the first section and the second section.

20. The article of claim 17, wherein the first section is configured to displace according to a first displacement-force profile, and the second section is configured to displace according to a second displacement-force profile,
the first displacement-force profile including a change in slope greater than that of the second displacement-force profile.
